(19) United States
(12) Patent Application Publication
(10) Pub. No.: US 2007/0185949 A1
(43) Pub. Date: Aug. 9, 2007

(54) Demodulation of a multi-level quadrature amplitude modulation signal

(75) Inventors: Rene Becker, Victoria (AU); Edwin Chung, Victoria (AU)

Correspondence Address: SCULLY SCOTT MURPHY & PRESSER, PC, 400 GARDEN CITY PLAZA, SUITE 300, GARDEN CITY, NY, 11530, US

(73) Assignee: NEC Corporation, Tokyo (JP)

(21) Appl. No.: 10/583,429

(22) PCT Filed: Dec. 17, 2004
(86) PCT No.: PCT/JP04/19462

§ 371 Date: Jun. 19, 2006

(30) Foreign Application Priority Data
Dec. 17, 2003 (AU) 2003906998
Dec. 15, 2004 (AU) 2004240146

(51) Int. Cl. G06F 7/38

(52) U.S. Cl. 708/446

(57) ABSTRACT

A device (5) for determining k representative of the magnitude A of an orthogonal component of a Quadrature Amplitude Modulation (QAM) symbol, including:
multi-stage binary search circuitry (21) for conducting a multi-stage binary search for the value of A between predetermined maximum and minimum values Aₘₐₓ and Aₘᵢₙ, each stage producing a single bit binary output; and
integer value construction circuitry (22) for constructing the integer value k by juxtaposing the binary outputs from consecutive stages of the binary search,
where W=(Aₘₐₓ−Aₘᵢₙ)/n,
n equals 2ⁱ and i is an integer,
Aₘₐₓ is a maximum detectable level of the magnitude A,
Aₘᵢₙ is a minimum detectable level of the magnitude A, and W is the incremental level between consecutive values of the integer value k

The present invention relates generally to the demodulation of quadrature amplitude modulation (QAM) signals, and in particular to the determination of an integer value, representative of the magnitude of an orthogonal component of a quadrature amplitude modulation symbol, used in the calculation of a threshold value(s) for efficient demodulation of the signal. The invention has particular application to code division multiple access and other spread spectrum receivers, and it will be convenient to describe the invention in relation to that application. It is to be appreciated however, that the invention is not limited to use in this application only.

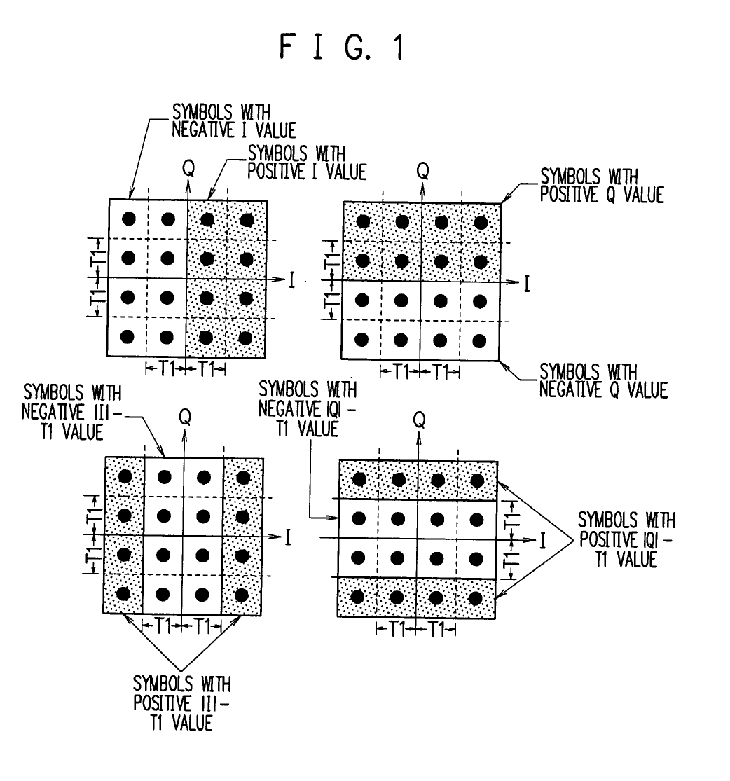

At the heart of a QAM demodulator is a device that reconverts each received symbol back to its original digital data representation. In an ideal scenario, the received symbols will have a constellation where the coordinates for all symbols within the constellation are well defined. In this case, it would be possible to determine the equivalent data representation of each received symbol by determining the relative position of the symbol within the constellation using a present threshold value(s) as depicted in FIG. 1.

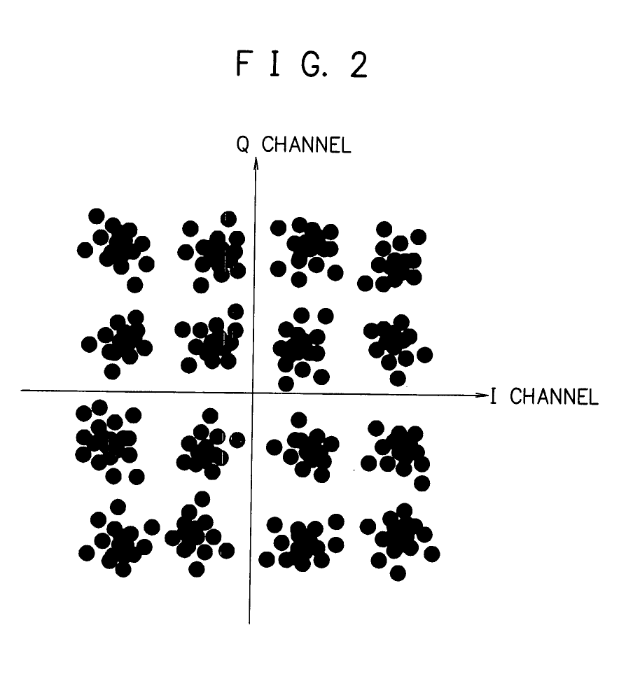

However, in the presence of noise and fading commonly experienced in the transmission media, the received constellation will be dispersed as depicted in FIG. 2. The threshold value needed to perform the demodulation will also vary with channel condition. As a means to having an adaptive demodulator, techniques to derive the threshold value required to perform the demodulation which analyses the histogram of |I| and |Q| (the magnitude of the I and Q components) of received symbols have been proposed.

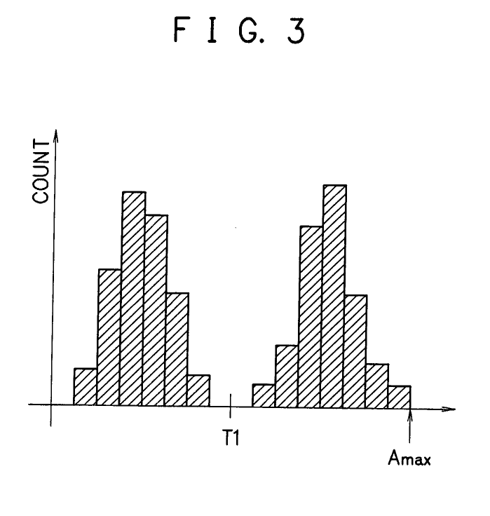

An example of a histogram of received symbols is depicted in FIG. 3 to illustrate how the threshold value required to demodulate the received symbols may be derived from the histogram. In this figure, the histogram has been limited to some maximum amplitude Aₘₐₓ which may be predetermined. A hardware implementation capable of building such a histogram in its internal memory representation will need to be able to determine the associated bin/bar in the histogram given the amplitude of an I or a Q component.

The task of determining the associated bin/bar in the histogram given an amplitude, A, and the maximum amplitude for the histogram, Aₘₐₓ, can be stated mathematically as the need to determine the value k representative of an orthogonal component of a received QAM modulated symbol which satisfies the following condition, where W is Aₘₐₓ divided by the resolution of histogram (i.e., the number of bins/bars).
W×k≦A<W×(k+1)
An added complexity is created by the fact that A, Aₘₐₓ and W are commonly floating point numbers.

From the perspective of a spread spectrum mobile receiver, an optimal design in terms of silicon area and power consumption is highly desirable. An effective design that is capable of computing k with the least delay (i.e., within the shortest possible clock period) is also highly desirable.

One aspect of the invention provides a device for determining k representative of the magnitude A of an orthogonal component of a Quadrature Amplitude Modulation (QAM) symbol, including:

multi-stage binary search circuitry for conducting a multi-stage binary search for the value of A between predetermined maximum and minimum values Aₘₐₓ and Aₘᵢₙ, each stage producing a single bit binary output; and

integer value construction circuitry for constructing the integer value k by juxtaposing the binary outputs from consecutive stages of the binary search,

where W=(Aₘₐₓ−Aₘᵢₙ)/n,

n equals 2ⁱ and i is an integer,

Aₘₐₓ is a maximum detectable level of the magnitude A,

Aₘᵢₙ is a minimum detectable level of the magnitude A, and

W is the incremental level between consecutive values of the integer value k.

A device having these features advantageously avoids the need to carry out division operations, and facilitates an efficient hardware implementation which maximises the use of simple circuit elements such as adders, comparators, multiplexers and registers.

In at least one embodiment, each orthogonal component sample and the predetermined maximum value Amax are in a floating point format comprising a mantissa and an exponent. In this case, the circuitry may include exponent normalizing circuitry for bit-shifting the mantissa until the exponent is identical to the exponent of the predetermined maximum value Aₘₐₓ.

Use of the exponent normalizing circuitry enables comparisons between the orthogonal component samples and the predetermined maximum value Aₘₐₓ to be made by the processing of integers only, without requiring floating point processing circuitry.

In at least one embodiment, the predetermined minimum value Aₘᵢₙ is zero, and the multi-stage binary search circuitry includes a first stage search element and one or more subsequent stage search elements, the first stage search element including a bit shift block for determining the mid-point between the predetermined maximum value Aₘₐₓ and zero.

Each subsequent stage search elements may include an adder for determining the mid-point between upper and lower output values of a preceding search element.

The first stage search element and subsequent stage search elements may each include a comparator for comparing respectively the midpoint between predetermined maximum and minimum values Aₘₐₓ and Aₘᵢₙ, and the midpoint between upper and lower output values of a preceding search element, wherein the integer value k is constructed by the integer value constructing circuitry from the outputs of the comparators.

Another aspect of the invention provides a method for determining an integer value k representative of the magnitude A of an orthogonal component of a Quadrature Amplitude Modulation (QAM) symbol, the method including the steps of:

(a) conducting a multi-stage binary search for the value of A between predetermined maximum and minimum values Aₘₐₓ and Aₘᵢₙ, each stage producing a single binary output; and

(b) constructing the integer value k by juxtaposing the binary outputs from consecutive stages of the binary search,

where W=(Aₘₐₓ−Aₘᵢₙ)/n,

n equals 2ⁱ and i is an integer,

Aₘₐₓ is a maximum detectable level of the magnitude A,

Aₘᵢₙ is a minimum detectable level of the magnitude A, and

W is the incremental level between consecutive values of the integer value k.

The following description refers in more detail to the various features of the present invention. To facilitate an understanding of the invention, reference is made in the description to the accompanying drawings where the demodulation device is illustrated in a preferred embodiment. It is to be understood that the present invention is not limited though to the preferred embodiment as illustrated in the drawings.

In the drawings:

FIG. 1 is a schematic diagram of an ideal 16 QAM received symbol constellation;

FIG. 2 is a schematic diagram showing a 16 QAM constellation in the presence of noise in the transmission medium;

FIG. 3 is a histogram of received symbols in a 16 QAM constellation;

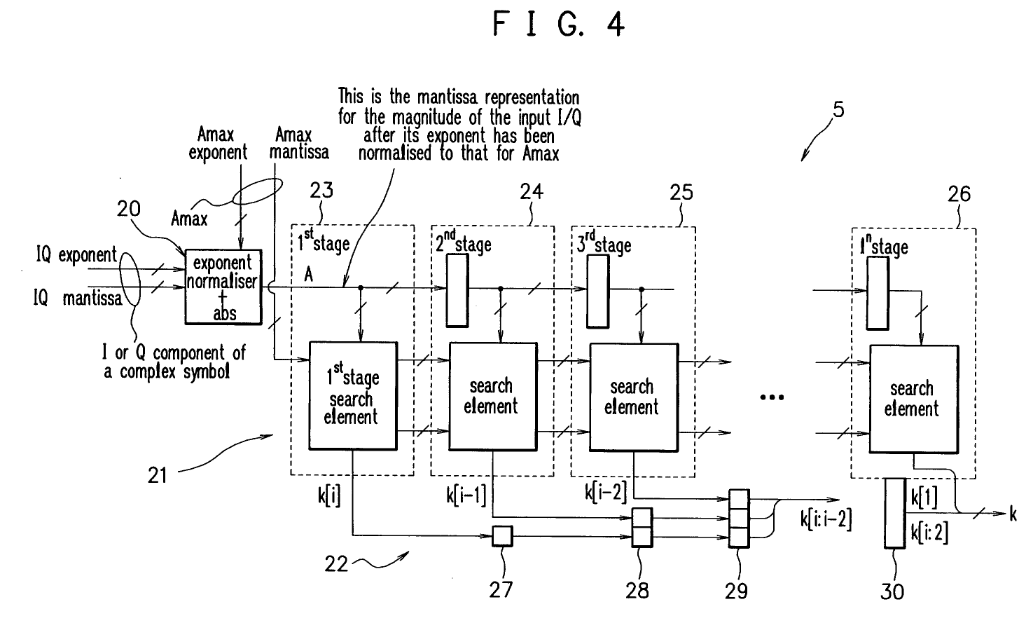

FIG. 4 is a schematic diagram of a device for determining integer value, k, representative of the magnitude of an orthogonal component of a QAM symbol, according to one embodiment of the present invention;

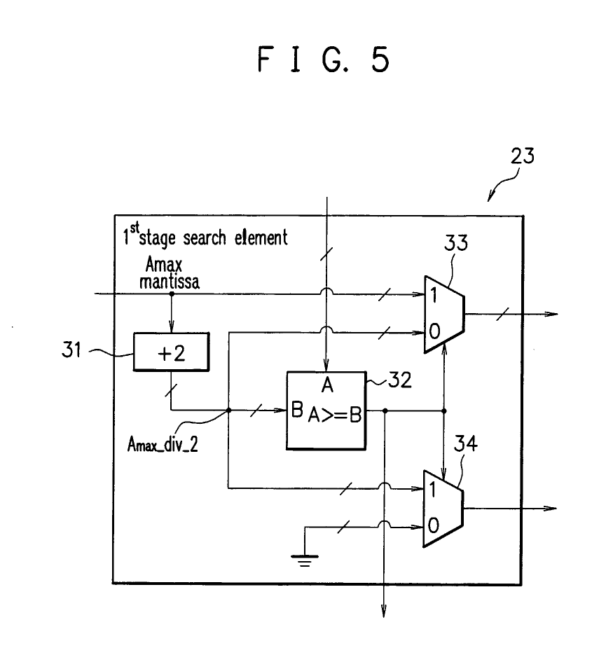

FIG. 5 is a schematic diagram of a first embodiment of a first stage search element;

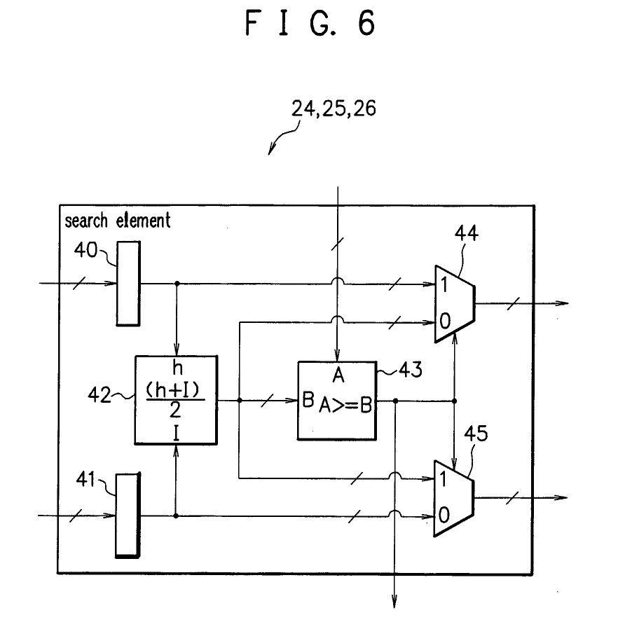

FIG. 6 is a schematic diagram showing one embodiment of a subsequent stage search element;

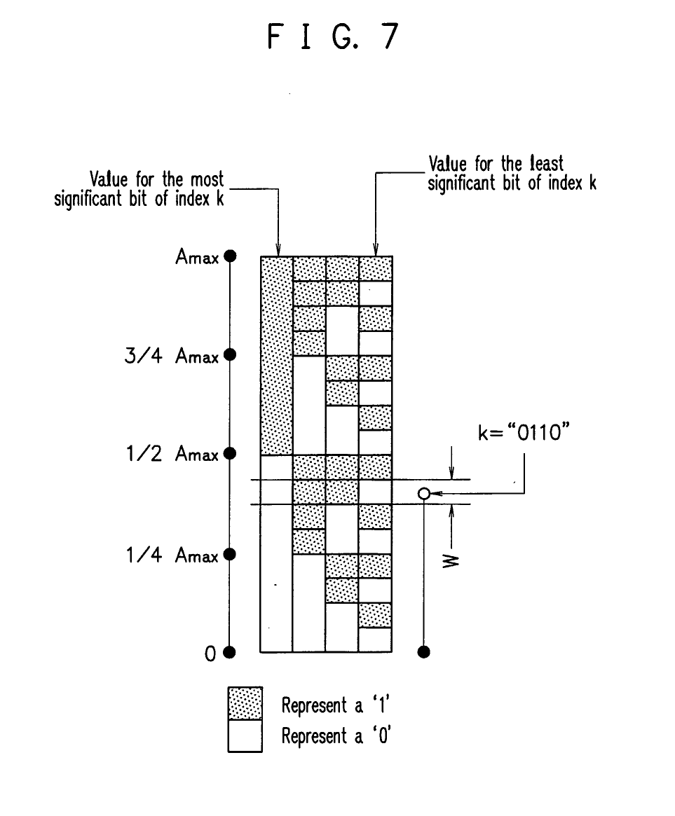

FIG. 7 is a representation of the manner in which integer value, k, representative of the magnitude of the I/Q components of a QAM symbol;

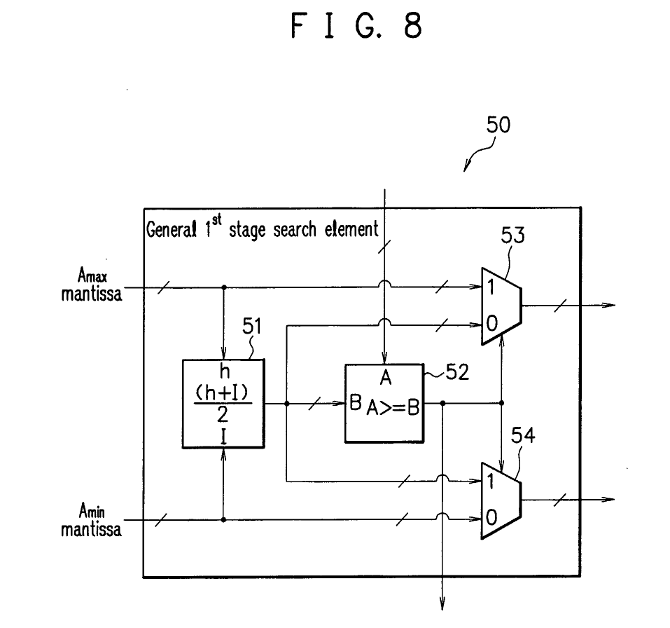

FIG. 8 is a schematic diagram of a second embodiment of first stage search element.

Referring now to FIG. 4, there is shown a device 5 for determining integer value, k, representative of the magnitude of an orthogonal component of a QAM symbol forming part of the an adaptive QAM demodulation device. The device 5 includes an exponent normalizing block 20, a multi stage binary search block 21 and integer value constructing circuitry 22. The multi stage binary search circuitry 21 includes a first stage search element 23 and subsequent stage search elements 24 to 26. The integer value constructing circuitry includes registers 27 to 30 for storing binary outputs from consecutive stages of the binary search circuitry 21.

The exponent normalizing block 20 acts to compare the exponent of the floating point representation of the I/Q component to the exponent of a predetermine maximum value Aₘₐₓ. The block 20 also acts to determine the absolute value for the input I/Q component and bit shift the mantissa representation of that component until its exponent is identical to the exponent for Aₘₐₓ. In this way, the multi-stage binary search block 21 is reduced to an integer implementation, eliminating the need to perform floating point calculations.

The output of the exponent normalization block 20 and the mantissa of the predetermined maximum value Aₘₐₓ are provided as inputs to the first stage search element 23 of the multi-stage binary search block 21.

As can be seen in more detail in FIG. 5, the first stage element 23 includes a one bit right shift block 31, a comparator 32, and two multiplexers 33 and 34. The one bit right shift block 31 effectively performs a divide-by-two operation on the mantissa of the predetermined maximum value Aₘₐₓ. In other words, A_{max—}div_{—}2 is connected to Aₘₐₓ mantissa where the least significant bit of Aₘₐₓ mantissa is not used and the most significant bit of A_{max—}div_{—}2 is set to 0.

The output of the one bit right shift block 31 is provided to the B input of the comparator 32. The normalized mantissa representation of the magnitude A, as output from the exponent normalization block 20, is provided to the A input of the comparator 32. The predetermined maximum value Aₘₐₓ is provided to one input of the multiplexer 33, whilst the predetermined minimum value Aₘᵢₙ, in this case having a value of 0, is input to one of the inputs of the multiplexer 34. The output of the one bit right shift block 31, namely the mantissa of the value Aₘₐₓ divided by 2, is supplied to the other input of both multiplexers 33 and 34. The output of the comparator 32 is provided to an enable input of the multiplexers 33 and 34. If the comparator 32 determines that the normalized mantissa of the magnitude A of the I/Q component is greater than one half of Aₘₐₓ, then the binary string representative of the mantissa of Aₘₐₓ is reproduced at the output of the multiplexer 33 and the binary string representative of one half of Aₘₐₓ is transmitted by the multiplexer 34.

Alternatively, if the value at the A input of the comparator 32 is less than the value of the B input, the binary string representative of the value one half of Aₘₐₓ is transmitted by the multiplexer 33, and a binary string of 0 value is transmitted by the multiplexer 34.

The output of the multiplexers 33 and 34 are provided as inputs to the second stage search element 24. A more detailed view of the second and subsequent stage of the search elements is shown in FIG. 6. The search elements 24, 25 and 26 include registers 40 and 41 respectively for storing the outputs of the two multiplexes from a preceding search element, and adder block 42, a comparator 43 and two multiplexers 44 and 45. The two values input to the registers 40 and 41 from a preceding search stage correspond to upper and lower values between which the magnitude A of the input I/Q component is located. In accordance with known binary search techniques, the range between the upper and lower output values stored in the registers 40 and 41 corresponds to half the range of the upper and lower output values from a preceding search element (or in the case of the first stage search element the predetermined maximum and minimum values Aₘₐₓ and Aₘᵢₙ).

The outputs of the two registers 40 and 41 are provided to the inputs of the block 42, which implements a function

$$( \frac{h + l}{2} )$$

where h and l are the two values stored in the registers 40 and 41. In fact, the block 42 implements this function with a simple adder. As was the case in the above described first stage search element, the divide-by-two operation performed after the addition of h to l is nothing more than a one bit right shift operation that is implemented by the physical connections made to the adder.

The block 42 acts to determine the mid point between the values stored in the registers 40 and 41, and provides this value to the B of the comparator 43. The normalized value of the magnitude A of the input I/Q component is provided to the other A input of the comparator 43. Depending upon that normalized value is greater than the mid point determined by the block 42, or less than that mid point value, the multiplexes 44 and 45 will respectively output upper and lower values corresponding either to the value stored in the register 40 and the mid point as determined by the block 42, or the mid point and the value stored in the register 41.

As can be seen in FIG. 4, the binary output from each of the comparators in the search elements 23 to 26 are stored in registers 27 to 30. By juxtaposing the binary output from consecutive stages of the binary search circuitry, and integer value k representative of the magnitude A of the input I/Q component is derived.

Prior to examining at how the above desired hardware implementation generates the integer value k, given A and Aₘₐₓ consider first the binary value for k and its relation to W and Aₘₐₓ as depicted in FIG. 7. An important aspect of the present invention is that the integer value, k, can be constructed whilst the region where A lies within the range from 0 to Aₘₐₓ is being refined and searched for in a binary search fashion. A prerequisite for the previous statement to be valid is that W=Aₘₐₓ/n where the value for n satisfies the condition n∈{2ⁱ|i∈IN}.

In other words, if the range from 0 to Aₘₐₓ is divided into n equal regions, the integer value k will have a bit width of i where n=2ⁱ and the most significant bit of k is l if A≧ (Aₘₐₓ+0)/2. It is 0 otherwise. After having determined if A lies on the upper or lower half in the full range from 0 to Aₘₐₓ, the most significant bit of the remaining (i−1) underfined bits in k can again be determined in the same manner by determining if it is in the upper or lower quarter in the half that it is known to be in. This process is repeated for each of the remaining (i−2) bits of k halving the search range in each subsequent search in each subsequent search element. Recall that W=Aₘₐₓ/n and n∈{2ⁱ|i∈IN}. This being the case, the binary value for k for each of the n sub-regions will be such that the most significant bit of k has a value 1 on the top half of the scale from 0 to Aₘₐₓ. It has a value 0 on the lower half. Within each of these halves, the next less significant bit of k will again have the value 1 on the upper quarter and 0 on the lower. The same is again applicable to the next less significant bit of k over each of the 4 quarters.

Given the exponent normalized magnitude A of an I/Q component, the integer value k which satisfies the condition W×k≦A<W×(k+1) can be determined by first determining if A lies on the upper or lower half between 0 to Aₘₐₓ. As described above, the most significant bit of k will have a value 1 if it is. Accordingly, the design of the first stage search element 23 is such that it determines if A≧Aₘₐₓ/2. The most significant bit of k is set to 1 if it is. It will be set to a 0 otherwise. Having determined if A lies on the upper or the lower halves, the upper and lower bound of the halves A lies in is then multiplexed to the search element in the following stage. This search element 23 will first determine the mid-point between the upper and lower limits and again checking if A lies above or below this mid-point setting the next least significant bit of k accordingly. The upper and lower limit for the search element for the next stage is also set in the same way. This is repeated for the bit width of k. In other words, the bit value of k is being constructed as the region where A lies in the scale from 0 to Aₘₐₓ is being refined and searched for in a binary search fashion.

As an example, consider a case where Aₘₐₓ=0.0110111000×2¹, n=16 and an I/Q component of −0.1010110100×2⁻¹. n having the value 16 means that i is 4 which in turn implies that k is represented by a 4 bit binary number and that the corresponding implementation will be a 4-stage search-element pipeline.

Assume for the purpose of this illustration that the mantissa for Aₘₐₓ has a binary representation of 0110111000. The value for A at the output of the exponent normalization block 20 would then be 0.0010101101 and is simply represented in the implementation as 0010101101.

In the first stage search element 23, the mantissa representation for Aₘₐₓ is connected to the comparator 31 such that A is compared to 0011011100. Since 0010101101 is less than 0011011100, the output of the comparator 31 will be 0. This being the case, the output for the multiplexers 32 and 33 at the top and the bottom of the search element 23 will have the value 0011011100 and 0000000000 respectively. These values, A and the output of the comparator 31 will be clocked into the respective registers 40 and 41 in the subsequent search element.

The output of the block 42 implementing the

$$( \frac{h + l}{2} )$$

function will have the value 0001101110 and the comparator 43 will then compare the value of A=0010101101 to 0001101110. Since 0010101101 is greater than 0001101110, the output of the comparator 43 will be a 1. Accordingly, the output of the multiplexers 44 and 45, at the top and the bottom for this second stage search-element 24 will be 0011011100 and 0001101110 respectively. As with the previous stage, these values, A and the output of the comparator 43 will be clocked into the respective registers 40 and 41 in the subsequent stage. The previously clocked most significant bit of k derived by the previous stage will also be clocked into the next stage.

In a similar manner, A=0010101101 is compared to 0010100101 and since A is greater than this value, the output of the comparator will be set to 1 multiplexing the values, 0011011100 and 0010100101 at the output of the top and bottom muxes of this stage. At the final stage, the value of A is compared with 0011000000 and since A is smaller than this value, the output of the comparator is set to 0. Thus giving a binary value of 0110 for the value of k.

It will be noted that the value for W need not be calculated to determine the value for k. Also, it will be appreciated the two multiplexes in the final search-element are redundant and may be removed from the circuit design. Moreover, being structured in this example as a 4-stage pipeline, it will take 4 clock cycles to fill the pipeline and to obtain the first k value. Once the pipeline is filled, it will be able to process 1 input I/Q component data per clock cycle.

FIG. 8 shows a detailed view of an alternative embodiment of the first stage search element 23. In this alternative embodiment, the first stage search element 50 includes a comparator 52 and multiplexers 53 and 54 identical in operation to those described in relation to FIG. 5. However, in this embodiment the initial value of the mantissa of the predetermined minimum value Aₘᵢₙ is non-zero, and as a consequence the one bit right shift operation block 30 is replaced by an adder 51 operating in the same manner as the adder 42 described in relation to FIG. 6. Moreover, it will be necessary to derive a normalized exponent of the predetermined minimum value Aₘᵢₙ in the same manner as described above in relation to the predetermined maximum value Aₘₐₓ.

Those skilled in the art will appreciate that there may be many modifications and variations of the configuration described above which are within the scope of the present invention.

1. A device for determining k representative of the magnitude A of an orthogonal component of a Quadrature Amplitude Modulation (QAM) symbol, including:
multi-stage binary search circuitry for conducting a multi-stage binary search for the value of A between predetermined maximum and minimum values Aₘₐₓ and Aₘᵢₙ, each stage producing a single bit binary output; and
integer value construction circuitry for constructing the integer value k by juxtaposing the binary outputs from consecutive stages of the binary search,
where W=(Aₘₐₓ−Aₘᵢₙ)/n,
n equals 2ⁱ and i is an integer,
Aₘₐₓ is a maximum detectable level of the magnitude A,
Aₘᵢₙ is a minimum detectable level of the magnitude A, and
Wᵢₛ the incremental level between consecutive values of the integer value k.

2. A device according to claim 1, wherein each orthogonal component sample and the predetermined maximum value Aₘₐₓ are in a floating point format comprising a mantissa and an exponent, and wherein the multi-stage binary circuitry includes exponent normalizing circuitry for bit-shifting the mantissa until the exponent is identical to the exponent of the predetermined maximum value Aₘₐₓ.

3. A device according to either one of claims 1 or 2 wherein the predetermined minimum value Aₘᵢₙ is zero, and the multi-stage binary search circuitry includes a first stage search element and one or more subsequent stage search elements, the first stage search element including a bit shift block for determining the mid-point between the predetermined maximum value Aₘₐₓ and zero.

4. A device according to claim 3, wherein each subsequent stage search elements includes an adder for determining the mid-point between upper and lower output values of a preceding search element.

5. A device according to either one of claims 3 or 4, wherein the first stage search element and subsequent stage search elements each include a comparator for comparing respectively the midpoint between predetermined maximum and minimum values Aₘₐₓ and Aₘᵢₙ, and the midpoint between upper and lower output values of a preceding search element, and wherein the integer value k is constructed by the integer value constructing circuitry from the outputs of the comparators.

6. A method for determining an integer value k representative of the magnitude A of an orthogonal component of a Quadrature Amplitude Modulation (QAM) symbol, the method including the steps of:
(a) conducting a multi-stage binary search for the value of A between predetermined maximum and minimum values Aₘₐₓ and Aₘᵢₙ, each stage producing a single binary output; and
(b) constructing the integer value k by juxtaposing the binary outputs from consecutive stages of the binary search,
where W=(Aₘₐₓ−Aₘᵢₙ)/n,
n equals 2ⁱ and i is an integer,
Aₘₐₓ is a maximum detectable level of the magnitude A,
Aₘᵢₙ is a minimum detectable level of the magnitude A, and
W is the incremental level between consecutive values of the integer value k.

7. A method according to claim 6 wherein, each orthogonal component sample and the predetermined maximum value Aₘₐₓ are in a floating point format comprising a mantissa and an exponent, the method further including the step of bit-shifting the mantissa until the exponent is identical to the exponent of the predetermined maximum value Aₘₐₓ.

8. A method according to either one of claims 6 or 7, wherein the predetermined minimum value Aₘᵢₙ is zero, and wherein the multi-stage binary search includes a first stage and one or more subsequent stages, the first stage including conducting bit shifting to determine the mid-point between the predetermined maximum value Aₘₐₓ and zero.

9. A method according to claim 8, wherein each subsequent stage includes determining the mid-point between upper and lower output values of a preceding search stage.

10. A method according to either one of claims 8 or 9, wherein the first stage and subsequent stages each include comparing respectively the midpoint between predetermined maximum and minimum values Aₘₐₓ and Aₘᵢₙ, and the midpoint between upper and lower output values of a preceding search element, and wherein the integer value k is constructed from the results of the comparisons.
